(19) United States
(12) Patent Application Publication
(10) Pub. No.: US 2024/0257531 A1
(43) Pub. Date: Aug. 1, 2024

(54) TECHNIQUES TO IMPLEMENT TRANSFORMERS WITH MULTI-TASK NEURAL NETWORKS

(71) Applicant: Micron Technology, Inc., Boise, ID (US)

(72) Inventors: Parth Khopkar, Seattle, WA (US); Shakti Nagnath Wadekar, West Lafayette, IN (US); Abhishek Chaurasia, Redmond, WA (US); Andre Xian Ming Chang, Bellevue, WA (US)

(21) Appl. No.: 18/420,489

(22) Filed: Jan. 23, 2024

Related U.S. Application Data
(60) Provisional application No. 63/442,081, filed on Jan. 30, 2023.

(51) Int. Cl. G06V 20/58; G06V 10/82

(52) U.S. Cl. CPC G06V 20/58; G06V 10/82

(57) ABSTRACT

Methods, systems, and devices for techniques to implement transformers with multi-task neural networks are described. A vehicle system may employ one or more transformer models in a machine learning system to generate an indication of a one or more objects in an image, one or more drivable areas in an image, one or more lane lines in an image, or a combination thereof. The multi-task system may include a feature extractor which uses a set of convolutional layers to generate a corresponding set of representation vectors of the image. The system may pass the representation vectors to a set of transformer models, such that each of the transformer models share a common input. Each transformer model may use the representation vectors to generate a respective indication.

### CROSS REFERENCE

The present Application for Patent claims the benefit of U.S. Provisional Patent Application No. 63/442,081 by KHOPKAR et al., entitled “TECHNIQUES TO IMPLEMENT TRANSFORMERS WITH MULTI-TASK NEURAL NETWORKS,” filed Jan. 30, 2023, assigned to the assignee hereof, and expressly incorporated by reference in its entirety herein.

### TECHNICAL FIELD

The following relates to one or more systems for memory, including techniques to implement transformers with multi-task neural networks.

### BACKGROUND

Modern vehicle systems include various sensors, such as cameras, to record the environment surrounding the vehicle. Vehicle systems further include memory and processing devices to analyze sensor data (e.g., video streams, still images) and detect features of the environment, such as lanes of roads, other vehicles, traffic signs, pedestrians, and the like. Such processing devices may implement machine learning techniques to process the sensor data. For example, an image from the sensor data may act as an input to a machine learning model, and the machine learning model may detect objects or other environmental features within the image. The processing devices may implement multiple machine learning models, which may each perform a specific task, or the processing devices may implement machine learning models which each perform multiple tasks.

### BRIEF DESCRIPTION OF THE DRAWINGS

FIG. 1 illustrates an example of a system that supports techniques to implement transformers with multi-task neural networks in accordance with examples as disclosed herein.

FIG. 2 illustrates an example of a system that supports techniques to implement transformers with multi-task neural networks in accordance with examples as disclosed herein.

FIG. 3 illustrates an example of a system that supports techniques to implement transformers with multi-task neural networks in accordance with examples as disclosed herein.

FIG. 4 illustrates an example of a system that supports techniques to implement transformers with multi-task neural networks in accordance with examples as disclosed herein.

FIG. 5 illustrates an example of a system that supports techniques to implement transformers with multi-task neural networks in accordance with examples as disclosed herein.

FIG. 6 illustrates a block diagram of a machine learning trained autonomous driving system that supports techniques to implement transformers with multi-task neural networks in accordance with examples as disclosed herein.

FIG. 7 illustrates a flowchart showing a method or methods that support techniques to implement transformers with multi-task neural networks in accordance with examples as disclosed herein.

### DETAILED DESCRIPTION

Some systems, such as a vehicle system, may implement machine learning models to identify properties of an environment associated with the vehicle system. For example, a vehicle may include a camera system which may record a video stream of the environment. The vehicle may process the video stream using a machine learning model, such as a multi-task neural network, to perform multiple machine learning tasks. For example, the machine learning model may identify and label one or more objects, such as other vehicles (e.g., second vehicles), pedestrians, traffic signs, in the video stream, may identify drivable areas (e.g., available lanes, portions of the video stream corresponding to a road), may identify lane lines between lanes, or a combination thereof. However, a multi-task neural network may use significant resources, such as computational time, power consumption, memory associated with storing the multi-task neural network, or a combination thereof. Because resources may be limited on a vehicle system (e.g., compared with other systems which employ machine learning models, such as servers), techniques to improve efficiency of multi-task machine learning are desired.

As described herein, a vehicle system may employ one or more transformer models in a multi-task machine learning system to generate an indication of a one or more objects (e.g., one or more second vehicles) in an image (e.g., an image of a video stream captured by a camera of the vehicle), one or more drivable areas in an image, one or more lane lines in an image, or a combination thereof. For example, the multi-task machine learning system may include a feature extractor (e.g., a backbone) which uses a set of convolutional layers to generate a corresponding set of representation vectors of the image. The system may pass the representation vectors to a set of transformer models, such that each of the transformer models share a common input. Each transformer model may use the representation vectors to generate respective indications. For example, the multi-task machine learning system may include a first transformer model to generate an indication of one or more objects in the image and a second transformer model to generate an indication of one or more drivable areas in the image. Because a transformer model may use relatively fewer resources, such as fewer floating point operations per second (FLOPs), to perform a task (e.g., compared with other machine learning models, such as a neural network), the multi-task machine learning system may improve efficiency in generating the indications.

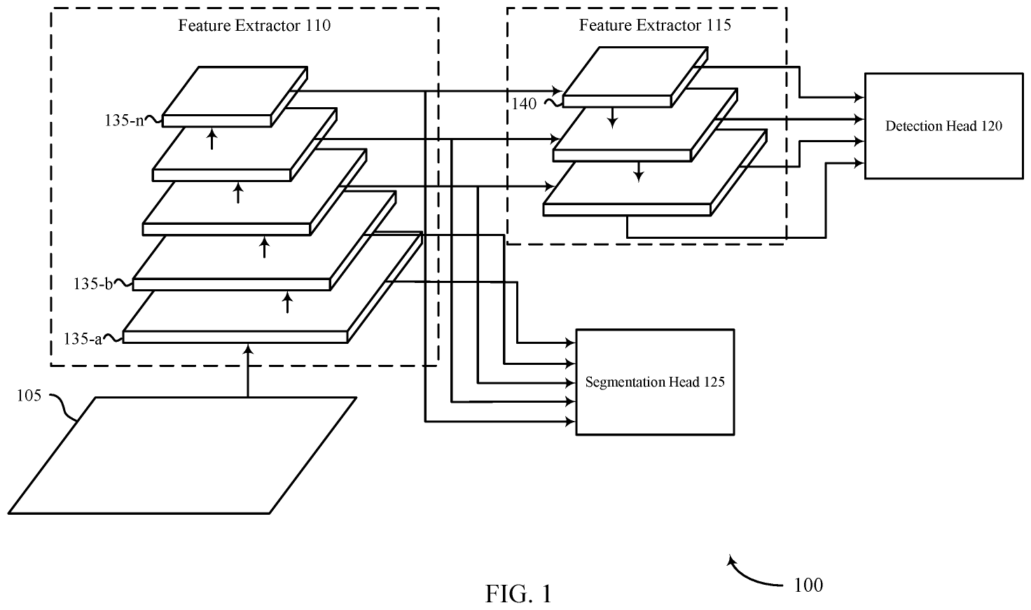

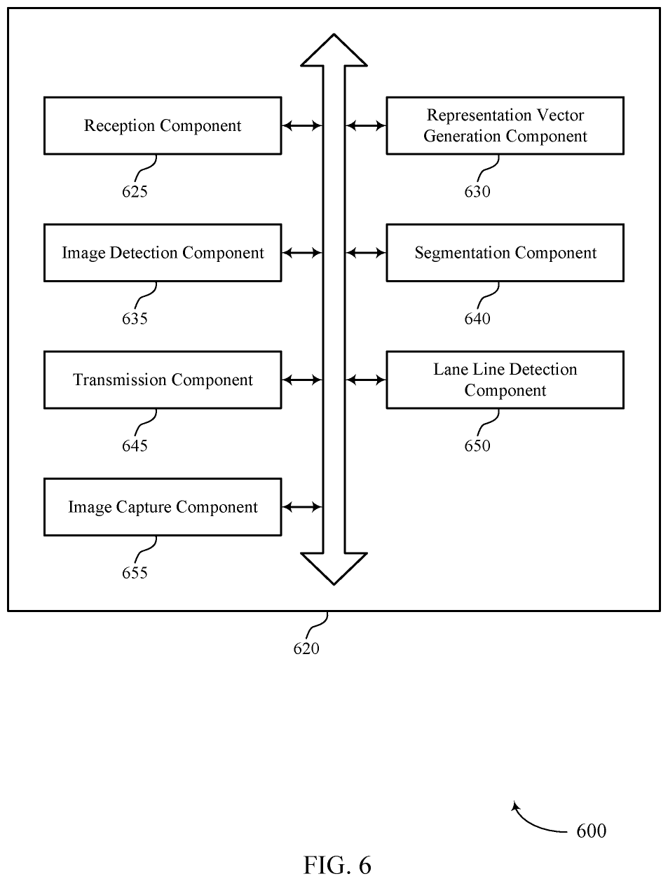

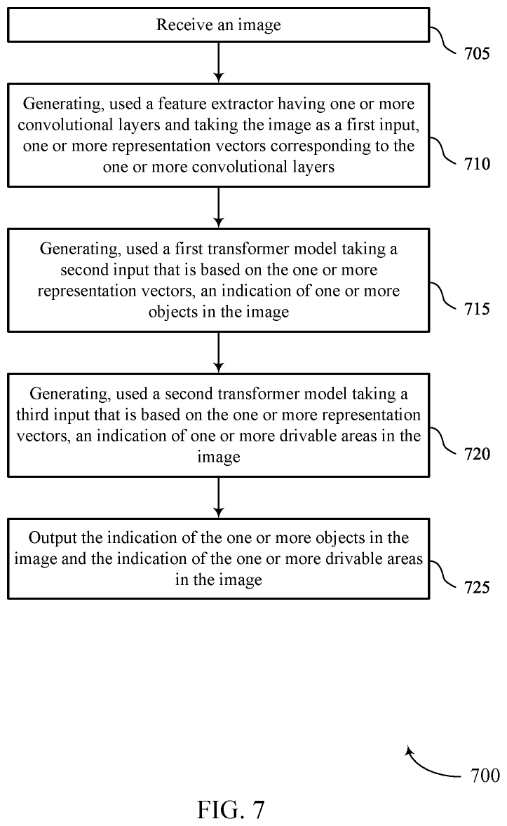

Features of the disclosure are initially described in the context of systems with reference to FIGS. 1 through 5. These and other features of the disclosure are further illustrated by and described in the context of an apparatus diagram and flowchart that relate to techniques to implement transformers with multi-task neural networks with reference to FIGS. 6 through 7.

FIG. 1 illustrates an example of a system 100 that supports techniques to implement transformers with multi-task neural networks in accordance with examples as disclosed herein. The system 100 may illustrate a multi-task machine learning model configured to detect aspects of an image 105. The image 105 may be an image or a portion of a video stream of an environment surrounding a vehicle. In some examples, components on a vehicle may capture the image 105 using a camera system, and may provide the image 105 to a computing platform configured to implement the system 100. The system 100 may analyze the image 105 to identify: one or more objects in the image 105, such as one or more second vehicles (e.g., other vehicles in the vicinity of the vehicle implementing the system 100); one or more drivable areas in the image 105 (e.g., one or more portions of a road included in the image 105 available to the vehicle); one or more lanes lines in the image 105 (e.g., lane lines defining one or more lanes of the road); or a combination thereof. The system 100 may provide the identified features to other components of the vehicle, such as an autonomous driving component, a display component for a driver of the vehicle, a safety system of the vehicle, or a combination thereof.

The system 100 may implement a set of machine learning models to identify the features of the image 105. For example, the system 100 may include a feature extractor 110, which may be an example of a convolutional neural network that includes a set of convolutional layers 135. The feature extractor 110 may take the image 105 (e.g., a vectorized representation of the image 105) as an input to generate a set of representational vectors of the image 105.

In some examples, each convolution layer 135 may generate a respective representation vector of the image 105, and may pass the representation vector to the next convolutional layer 135 as an input. For example, the convolutional layer 135-a may take the image 105 as an input and generate a first representation vector. The convolutional layer 135-a may pass the first representation vector to the convolutional layer 135-b as an input, and the convolutional layer 135-b may generate a second representational vector to pass to the next convolutional layer 135, and so on. The convolutional layer 135-b may pass the second representational vector to the next convolutional layer 135 (e.g., the n-th convolutional layer 135-n), such that each convolutional layer 135 of the feature extractor 110 may generate a respective representation vector. In some examples, a convolutional layer 135 may decrease the resolution of the image 105 relative to the representation vector received from the preceding convolutional layer 135.

In some cases, the feature extractor 110 may provide a subset of the representation vectors of the convolutional layers 135 to a second feature extractor 115. The second feature extractor 115 may include one or more convolutional layers 140, which may each generate a respective representation vector. In some cases, each convolutional layer 140 may increase the resolution of the image 105 relative to the representation vector received from the preceding convolutional layer 140. The second feature extractor 115 may provide the generated set of representation vectors to a detection head 120. Additionally, or alternatively, the feature extractor 110 may provide the representation vectors of the convolutional layers 135 directly to the detection head 120, a segmentation head 125, or both. In some examples, the feature extractor 110, the feature extractor 115, or both may additionally provide the one or more representation vectors to a lane line head.

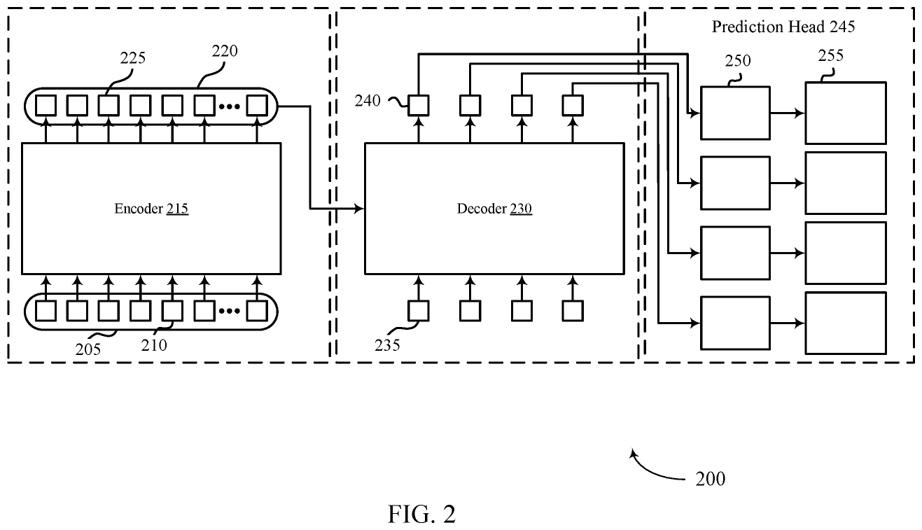

The detection head 120 may include one or more transformer models which may take the representative vectors as an input and generate an indication of one or more objects in the image 105. In some cases, each of the one or more transformer models may include or may be an example of a self-attention based transformer module. For example, each of the one or more transformer models may generate a representation (e.g., an attention matrix) which relates each entry of an input vector of the transformer model to an entry of a different position of the input vector. The indication of one or more objects may include a modification of the image 105. For example, detection head 120 may insert a visual marker, such as a box, around each of the detected objects (e.g., around each detected second vehicle). In some cases, the detection head 120 may include a set of transformer model blocks, such as an encoder block and a decoder block. Additionally, the detection head 120 may include one or more feed forward networks (FFNs) to generate the indication, as described in greater detail with reference to FIG. 2.

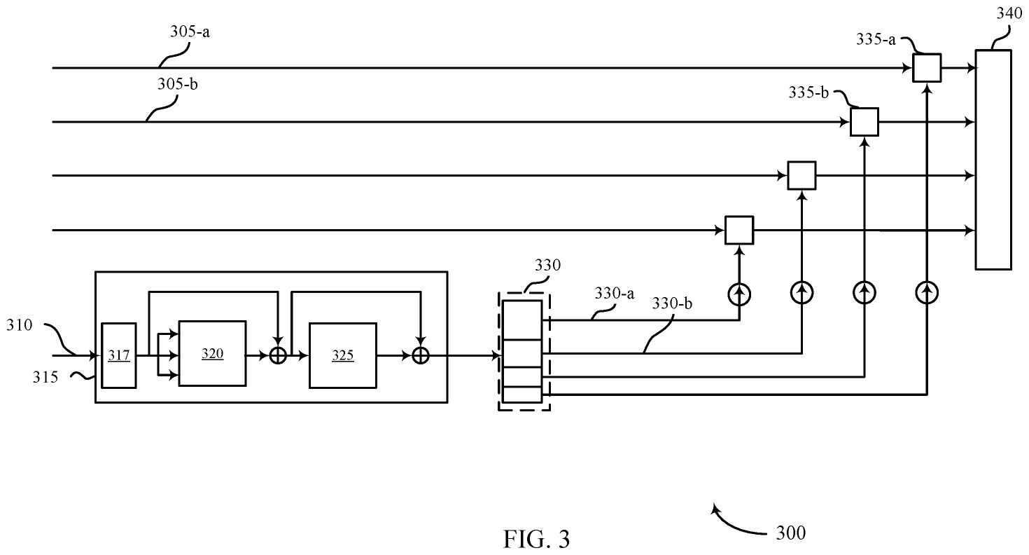

The segmentation head 120 may include one or more transformer models which may take the representative vectors as an input and generate an indication of one or more drivable areas in the image 105. In some cases, each of the one or more transformer models may include or may be an example of a self-attention based transformer module. For example, each of the one or more transformer models may generate a representation (e.g., an attention matrix) which relates each entry of an input vector of the transformer model to an entry of a different position of input vector. In some cases, the segmentation head 120 may include a set of transformer blocks, such as multi-head attention block, to generate the indication, as described in greater detail with reference to FIG. 3.

In some examples, a transformer model, such as the transformer models implemented in the detection head 120 and the segmentation head 125, may be examples of visual transformers (ViT), and may generate a set of vectors using trained weighted matrices, such as a key vector, a query vector, and a value vector, which may be used to perform image processing. The key vector and the query vector may be combined (e.g., using a tensor product) to generate an attention map, which may be combined with the value vector (e.g., via matrix multiplication) to generate an output probability. In some cases, an output probability may be an example of the indication of one or more objects, the indication of one or more drivable areas, or the indication of one or more lane lines. Additionally, or alternatively, the output probability may be passed to additional models to generate the indications, such as a prediction or segmentation head which includes an FFN.

Transformer models may be trained to detect selected objects in an image (e.g., cars, traffic signs), drivable areas in an image, or lane lines in an image. In some examples, a transformer model may provide benefits for image processing over other machine learning models, such as neural networks, such as significantly improved computational efficiency, improved accuracy of detection, or both.

In some examples, the system 100 may be implemented by a vehicle, such as an autonomous vehicle system configured to detect aspects of the environment in the vicinity of the vehicle. For example, the autonomous vehicle system may capture images of the surrounding environment and analyze the images to detect objects, such as other vehicles, pedestrians, or traffic signs, identify drivable portions of a road in the environment, identify lanes or lane lines within the road, or a combination thereof using multi-task machine learning models as described herein.

In some cases, the autonomous driving system may include dedicated hardware and software for analyzing the captured images. For example, the autonomous driving system may include one or more processors (e.g., one or more controllers), such as a deep learning accelerators (DLAs) to implement the multi-task machine learning models as described herein. A DLA may be an example of a deep learning device which may use a machine learning model to perform various operations. For example, the DLA may include neural networks, transformer models, or both that are trained to perform various inference tasks, such as data analytics, machine vision, voice recognition, and natural language processing, among other tasks for which neural networks may be trained. In some examples, the DLA may include a processor chipset and a software stack executed by the processor chipset. The processor chipset may include one or more cores, one or more caches (e.g., one or more memories local to or included in the DLA), and a storage protocol controller (e.g., PCIe controller), among other components. In some cases, the DLA may be a field programmable gate array (FPGA) based device, such as a modular FPGA-based architecture that implements an inference engine that may be tuned for various neural networks and transformer models.

In some examples, the DLA may operate multiple neural networks and transformer models concurrently. In some examples, a machine learning model may be implemented on a single DLA or across multiple DLAs. That is, the techniques described herein (e.g., neural networks, transformer models, or machine learning models, or the like) may be implemented by one or more controllers (e.g., one or more processors) of a computing system. In such examples, each of the one or more controllers may include, or be coupled with, one or more memories (e.g., caches, volatile memory, or non-volatile memory) and be configured to perform the operations described herein.

FIG. 2 illustrates an example of a system 200 that supports techniques to implement transformers with multi-task neural networks in accordance with examples as disclosed herein. The system 200 may be an example of aspects of the system 100 as described with reference to FIG. 1. For example, the system 200 may be an example of a detection head 120 as described with reference to FIG. 1.

The system 200 may take a vector 205 having values 210 as an input to an encoder 215. In some examples, the vector 205 may be determined by the representation vectors generated by the feature extractor 110, the feature extractor 115, or both. For example, the vector 205 may be a direct sum of the representation vectors of the feature extractor 115, such that, for each value 210 at an index of the vector 205, the value 210 corresponds to a sum of the values at the index of the representation vectors of the feature extractor 115.

The encoder 215 may include a series of transformer blocks (e.g., visual transformer blocks) which generate an output vector 220 having values 225. For example, a first transformer block may calculate a first attention map using the representation vector 205. The first transformer block may combine the first attention map with a value vector calculated using the representation vector 205 and pass the resulting output vector to a second transformer block, and so on to generate the output vector 220. The encoder 215 may pass the output vector 220 to the decoder 230 as an input.

The decoder 230 may take a set of object queries 235 as an input, which may correspond to classes of objects to be detected (e.g., vehicles, traffic signs, pedestrians). The decoder 230 may process the output vector 220 and object queries 235 using a series of transformer blocks to generate object embeddings 240 corresponding to the object queries 235. The decoder 230 may pass the object embeddings 240 to a prediction head 245.

The prediction head 245 may pass each object embedding 240 to a respective FFN 250, which may generate a respective indication 255 of the object associated with the object embedding 240. For example, if the set of object queries 235 includes an object query 235 for a vehicle, the FFN 250 may process the object embedding 240 to generate an indication 255 of a vehicle. In some examples, an indication 255 may include an indication of whether the associated object was detected in an image (e.g., the image 105). If the object was detected, the indication 255 may additionally include an indication of the object within the image, such as a box or other visual marker surrounding the object.

FIG. 3 illustrates an example of a system 300 that supports techniques to implement transformers with multi-task neural networks in accordance with examples as disclosed herein. The system 300 may be an example of aspects of the system 100 as described with reference to FIG. 1. For example, the system 300 may be an example of a segmentation head 125 as described with reference to FIG. 1.

The system 300 may take one or more inputs 305, which may correspond to the one or more representation vectors generated by the feature extractor 110. For example, the input 305-a may correspond to the output of the convolutional layer 135-a, the input 305-b may correspond to the output of the convolutional layer 135-b, and so on. The system 300 may take an additional input 310, which may be determined by each out the representation vectors of the feature extractor 110. For example, the input 310 may correspond to a combination, such as a concatenation, of each of the representation vectors of the feature extractor 110.

The input 310 may pass through an extractor 315 (e.g., a scale-aware semantics extractor) to generate semantic information 330. The extractor 315 may include a series of transformer blocks 317, which may each pass one or more inputs (e.g., one or more inputs corresponding to the one or more representation vectors included in the input 310) to an attention block 320 (e.g., a multi-head attention block). The attention block 320 may pass the one or more inputs through a set of key matrices, query matrices, and value matrices to generate a multi-head attention. The multi-head attention may then be combined with the one or more inputs and passed through an FFN 325. The output of the FFN 325 may be combined with the multi-head attention to generate an output of the transformer block, which may correspond to the semantic information 330. Although illustrated as having a single transformer block, the extractor 315 may include a series of any quantity of transformer blocks.

Because the input 310 may include each of the representation vectors of the feature extractor 110, the semantic information 330 may provide information of the image 105 as a whole, such as information associated with relationships between different features of the image 105. In some examples, the extractor 315 may generate semantic information 330 corresponding to each convolutional layer 135 of the feature extractor 110. For example, the extractor 315 may generate semantic information 330-a associated with the convolutional layer 135-a, semantic information 330-b associated with the convolutional layer 135-b, and so on.

The semantic information 330 may be up-sampled (e.g., dummy-values may be inserted into vectors representing the semantic information 330) and passed as an input, along with the associated input 305, to a set of semantic injection blocks 335. For example, the semantic information 330-a and the input 305-a may be passed to the semantic injection block 335-a, the semantic information 330-b and the input 305-b may be passed to the semantic injection block 335-b, and so on. The set of semantic injection blocks 335 may process the respective inputs, which may include applying a series of linear layers and batch normalizations to the inputs, to generate respective outputs to the head 340.

The head 340 may combine the outputs of the set of semantic injection blocks 335 to generate, by applying a series of linear layers and batch normalizations, an indication of drivable areas included in the image 105. In some cases, the indication may include a labeling of the pixels of the image 105. For example, the indication may include a categorization of each pixel of the image 105 as either a drivable area or a non-drivable area. Additionally, or alternatively, the head 340 may generate an indication of one or more lane lines included in the image 105.

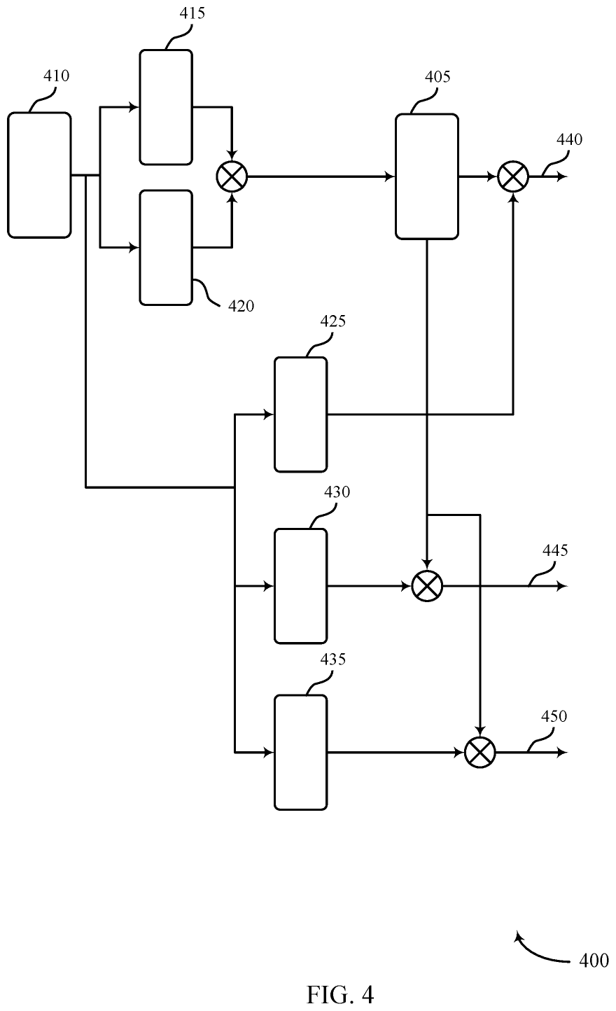

FIG. 4 illustrates an example of a system 400 that supports techniques to implement transformers with multi-task neural networks in accordance with examples as disclosed herein. The system 400 may be an example of aspects of the system 100 as described with reference to FIG. 1. For example, the system 400 may be an example of a feature extractor 115 as described with reference to FIG. 1. Additionally, or alternatively, the system 400 may be an example of an alternate architecture of the system 100.

The system 400 may be an example of a transformer model configured to generate an attention matrix 405 as part of performing multi-task image processing. For example, the system 400 may use the attention matrix 405 as part of generating the indication of one or more objects in the image 105, generating the indication of one or more drivable areas in the image 105, generating the indication of one or more lane lines in the image 105, or a combination thereof.

The system 400 may take one or more inputs 410, which may correspond to the one or more representation vectors generated by the feature extractor 110 or a subset thereof. The system 400 may generate a key vector 415 by applying a set of trained weights (e.g., by passing the one or more inputs 410 through a first linear layer, by applying a key matrix) to the one or more inputs 410 (e.g., a concatenated or vectorized form of the one or more inputs). Additionally, the system 400 may generate a query vector 420 by applying a set of trained weights (e.g., by passing the one or more inputs 410 through a second linear layer, by applying a query matrix) to the one or more inputs 410. To generate the attention matrix 405, the system 400 may combine the key vector 415 with the query vector 420, for example by multiplying the key vector 415 with the transpose of the query vector 420.

The system 400 may apply the attention matrix 405 to one or more value vectors to generate one or more representations, and may pass the one or more representations to respective heads, such as the detection head 120, the segmentation head 125, or both. For example, the system 400 may generate a first value vector 425 by applying a set of trained weights (e.g., by passing the one or more inputs 410 through a third linear layer, by applying a first value matrix) to the one or more inputs 410. In some examples, the first value vector 425 may correspond to (e.g., may be trained to support performing) a first type of task, such as generating an indication of one or more objects in the image 105. The system 400 may combine the attention matrix 405 with the first value vector 425 (e.g., by multiplying the first value vector 425 with the attention matrix 405) to generate the representation 440. Accordingly, the system 400 may pass the representation 440 to a detection head (e.g., the detection head 120) to generate the indication of one or more objects in the image 105. Additionally, or alternatively, the system 400 may pass a head which includes or implements alternate machine learning models to generate the indication, such as a neural network.

The system 400 may generate a second value vector 430 by applying a set of trained weights (e.g., by passing the one or more inputs 410 through a fourth linear layer, by applying a second value matrix) to the one or more inputs 410. In some examples, the second value vector 430 may correspond to (e.g., may be trained to support performing) a second type of task, such as generating an indication of one or more drivable areas in the image 105. The system 400 may combine the attention matrix 405 with the second value vector 430 (e.g., by multiplying the second value vector 430 with the attention matrix 405) to generate the representation 445. Accordingly, the system 400 may pass the representation 445 to a segmentation head (e.g., the segmentation head 125) to generate the indication of one or more drivable areas in the image 105. Additionally, or alternatively, the system 400 may pass a head which includes or implements alternate machine learning models to generate the indication, such as a neural network.

The system 400 may generate a third value vector 435 by applying a set of trained weights (e.g., by passing the one or more inputs 410 through a fifth linear layer, by applying a third value matrix) to the one or more inputs 410. In some examples, the third value vector 435 may correspond to (e.g., may be trained to support performing) a third type of task, such as generating an indication of one or more lane lines in the image 105. The system 400 may combine the attention matrix 405 with the third value vector 435 (e.g., by multiplying the third value vector 435 with the attention matrix 405) to generate the representation 450. Accordingly, the system 400 may pass the representation 450 to a segmentation head (e.g., the segmentation head 125) to generate the indication of one or more drivable areas in the image 105. Additionally, or alternatively, the system 400 may pass a head which includes or implements alternate machine learning models to generate the indication, such as a neural network.

Because the system 400 uses a common attention matrix 405 to generate the representations 440, 445, and 450, the system 400 may offer improvements over alternate implementations. For example, by calculating a single attention matrix 405 to generate representations for multiple tasks, the system 400 may reduce the computational cost (e.g., the quantity of FLOPs) used to generate the indications.

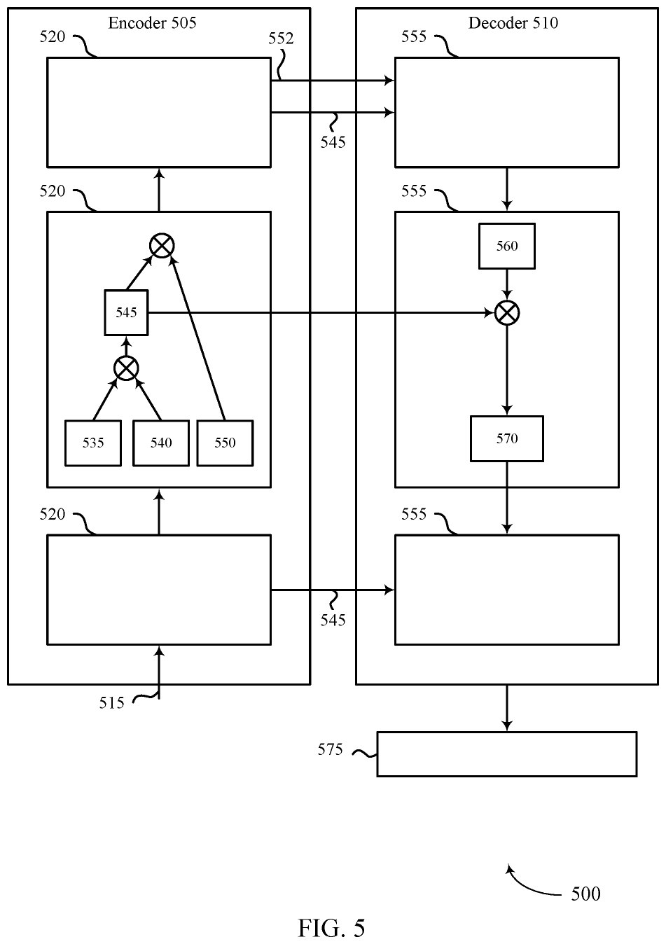

FIG. 5 illustrates an example of a system 500 that supports techniques to implement transformers with multi-task neural networks in accordance with examples as disclosed herein. For example, the system 500 may be an example of a detection head 120 or a segmentation head 125 as described with reference to FIG. 1.

The system 500 may include an encoder 505 and a decoder 510, which may implement a bypass (e.g., a focal bypass) to generate an indication of one or more drivable areas in the image 105, an indication of one or more lane lines in the image 105, or both. Additionally, or alternatively, the encoder 505 and the decoder 510 may generate an indication of one or more objects in the image 105. For example, the encoder 505 may pass an input 515, which may be based on the one or more representational vectors from the feature extractor 110 (e.g., a concatenation of the one or more representational vectors) through a series of transformer blocks 520.

In some examples, a transformer block 520 may implement a transformer model. For example, the transformer block 520 may use an input (e.g., the input 515 or the result of a preceding transformer block 520) to generate a key vector 535, a query vector 540, and a value vector 550 (e.g., by passing the input through respective linear layers). The transformer block 520 may generate an attention matrix 545, for example by multiplying the key vector 535 with a transpose of the query vector 540. The transformer block 520 may then generate an encoded vector 552, and may pass the encoded vector 552 to the next transformer block 520 of the encoder 505.

Alternatively, a transformer block 520 may pass an encoded vector 552 to the decoder 510, such as if the transformer block 520 is the last transformer block 520 of the encoder 505. The decoder 510 may pass the encoded vector 552 through a series of decoder blocks 555. In some examples, a decoder block 555 may be an example of a transformer block, and may generate a value vector 560 by applying an attention matrix to an input (e.g., the encoded vector 552 or the result of a preceding decoder block 555). Additionally, or alternatively, the decoder block 555 may be an example of one or more convolutional layers (e.g., or a CNN), and may generate the value vector 560 by passing the input through the one or more convolution layers. In some cases, a decoder block 555 using one or more convolutional layers may additionally apply an attention matrix to the input (e.g., before, within, or after passing through the one or more convolutional layers) to generate the value vector 560.

Rather than generating an attention matrix to apply to the value vector 560, the decoder block 555 may instead apply the attention matrix 545 from a corresponding transformer block 520 of the encoder 505 to the value vector 560 to generate a decoded vector, and thus bypass additional computations associated with generating an additional attention matrix. The decoder block 555 may pass the decoded vector through a layer 570, such as a linear layer or fully connected layer of trained weights, and pass the decoded vector to the next decoder block 555 of the decoder 510.

The decoder 510 may pass a decoded vector (e.g., from the final decoder block 555) to a head 575, which may generate, by applying a series of linear layers and batch normalizations, an indication, such as an indication of one or more objects, an indication of drivable areas, an indication of one or more lane lines, or a combination thereof included in the image 105. In some cases, the indication may include a labeling of the pixels of the image 105. For example, the indication may include a categorization of each pixel of the image 105 as either a drivable area or a non-drivable area.

FIG. 6 illustrates a block diagram 600 of a machine learning trained autonomous driving system 620 that supports techniques to implement transformers with multi-task neural networks in accordance with examples as disclosed herein. The machine learning trained autonomous driving system 620 may be an example of aspects of a machine learning trained autonomous driving system as described with reference to FIGS. 1 through 4. The machine learning trained autonomous driving system 620, or various components thereof (e.g., one or more controllers implementing, or implemented by, the machine learning trained autonomous driving system 620), may be an example of means for performing various aspects of techniques to implement transformers with multi-task neural networks as described herein. For example, the machine learning trained autonomous driving system 620 may include a reception component 625, a representation vector generation component 630, an image detection component 635, a segmentation component 640, a transmission component 645, a lane line detection component 650, an image capture component 655, or any combination thereof. Each of these components may communicate, directly or indirectly, with one another (e.g., via one or more buses).

The reception component 625 may be configured as or otherwise support a means for receiving an image. The representation vector generation component 630 may be configured as or otherwise support a means for generating, using a feature extractor having one or more convolutional layers and taking the image as a first input, one or more representation vectors corresponding to the one or more convolutional layers. The image detection component 635 may be configured as or otherwise support a means for applying one or more self-attention based transformers to a second input that is based on the one or more representation vectors to obtain an indication of one or more objects in the image. The segmentation component 640 may be configured as or otherwise support a means for applying the one or more self-attention based transformers to a third input that is based on the one or more representation vectors to obtain an indication of one or more drivable areas in the image. The transmission component 645 may be configured as or otherwise support a means for outputting the indication of the one or more objects in the image and the indication of the one or more drivable areas in the image.

In some examples, the lane line detection component 650 may be configured as or otherwise support a means for applying the one or more self-attention based transformers to a fourth input based on the one or more representation vectors to obtain an indication of one or more lane lines in the image.

In some examples, applying the one or more self-attention based transformers to the second input includes determining an attention matrix based on a key vector and a query vector associated with the one or more representation vectors and determining a first feature vector based on the attention matrix and a first value vector associated with the one or more representation vectors, where the indication of the one or more objects includes the first feature vector. In some examples, applying the one or more self-attention based transformers to the third input includes determining a second feature vector based on the attention matrix and a second value vector associated with the one or more representation vectors, where the indication of the one or more drivable areas includes the second feature vector.

In some examples, the lane line detection component 650 may be configured as or otherwise support a means for applying the one or more self-attention based transformers to a fourth input that is based on the one or more representation vectors to obtain an indication of one or more lane lines in the image, where applying the one or more self-attention based transformers to the fourth input includes determining a third feature vector based on the attention matrix and a third value vector associated with the one or more representation vectors, where the indication of the one or more lane lines includes the third feature vector.

In some examples, the one or more self-attention based transformers include an encoder including one or more first transformer blocks configured to generate an encoded vector based on the one or more representation vectors and a decoder including one or more decoder blocks configured to generate a decoded vector based on the encoded vector; and the indication of one or more drivable areas is based on the decoded vector.

In some examples, generating the encoded vector includes identifying one or more attention matrices at each of the one or more first transformer blocks. In some examples, generating the decoded vector includes applying, at a decoder block of the one or more decoder blocks, an attention matrix of the one or more attention matrices to a value vector associated with the decoder block.

In some examples, each decoder block of the one or more decoder blocks includes a respective second transformer block of one or more second transformer blocks.

In some examples, each decoder block of the one or more decoder blocks includes a respective second convolutional layer of one or more second convolutional layers.

In some examples, to support receiving the image, the image capture component 655 may be configured as or otherwise support a means for capturing the image from a camera of a vehicle. In some examples, to support receiving the image, the image capture component 655 may be configured as or otherwise support a means for inputting the image to a computing platform of the vehicle including the feature extractor and the one or more self-attention based transformers.

In some examples, the one or more objects in the image correspond to one or more second vehicles.

In some examples, the representation vector generation component 630 may be configured as or otherwise support a means for generating one or more second representation vectors using one or more second convolutional layers taking the one or more representation vectors as a fourth input, where the second input includes the one or more second representation vectors.

In some examples, the one or more self-attention based transformers include an encoder including one or more transformers configured to receive the second input, a decoder including one or more second transformers, and one or more feed forward networks, each feed forward network configured to identify a respective object of the one or more objects.

Further, the machine learning trained autonomous driving system 620 may include one or more controllers coupled with the one or more memories, where the one or more controllers and the one or more memories provide means for operating multi-task neural networks. The one or more controllers may implement, or be implemented by, the reception component 625, the representation vector generation component 630, the image detection component 635, the segmentation component 640, the transmission component 645, the lane line detection component 650, and the image capture component 655.

For example, the one or more controllers and the one or more memories may provide means for the machine learning trained autonomous driving system 620 to receive an image, generate, using a feature extractor having one or more convolutional layers and taking the image as a first input, one or more representation vectors corresponding to the one or more convolutional layers, apply one or more self-attention based transformers to a second input that is based on the one or more representation vectors to obtain an indication of one or more objects in the image, apply the one or more self-attention based transformers to a third input that is based on the one or more representation vectors to obtain an indication of one or more drivable areas in the image, and output the indication of the one or more objects in the image and the indication of the one or more drivable areas in the image.

FIG. 7 illustrates a flowchart showing a method 700 that supports techniques to implement transformers with multi-task neural networks in accordance with examples as disclosed herein. The operations of method 700 may be implemented by a machine learning trained autonomous driving system or its components as described herein. For example, the operations of method 700 may be performed by a machine learning trained autonomous driving system as described with reference to FIGS. 1 through 6. In some examples, a machine learning trained autonomous driving system may execute a set of instructions to control the functional elements of the device to perform the described functions. Additionally, or alternatively, the machine learning trained autonomous driving system may perform aspects of the described functions using special-purpose hardware.

At 705, the method may include receiving an image. The operations of 705 may be performed in accordance with examples as disclosed herein. In some examples, aspects of the operations of 705 may be performed by a reception component 625 as described with reference to FIG. 6.

At 710, the method may include generating, using a feature extractor having one or more convolutional layers and taking the image as a first input, one or more representation vectors corresponding to the one or more convolutional layers. The operations of 710 may be performed in accordance with examples as disclosed herein. In some examples, aspects of the operations of 710 may be performed by a representation vector generation component 630 as described with reference to FIG. 6.

At 715, the method may include applying one or more self-attention based transformers to a second input that is based on the one or more representation vectors to obtain an indication of one or more objects in the image. The operations of 715 may be performed in accordance with examples as disclosed herein. In some examples, aspects of the operations of 715 may be performed by an image detection component 635 as described with reference to FIG. 6.

At 720, the method may include applying the one or more self-attention based transformers to a third input that is based on the one or more representation vectors to obtain an indication of one or more drivable areas in the image. The operations of 720 may be performed in accordance with examples as disclosed herein. In some examples, aspects of the operations of 720 may be performed by a segmentation component 640 as described with reference to FIG. 6.

At 725, the method may include outputting the indication of the one or more objects in the image and the indication of the one or more drivable areas in the image. The operations of 725 may be performed in accordance with examples as disclosed herein. In some examples, aspects of the operations of 725 may be performed by a transmission component 645 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an image; generating, using a feature extractor having one or more convolutional layers and taking the image as a first input, one or more representation vectors corresponding to the one or more convolutional layers; applying one or more self-attention based transformers to a second input that is based on the one or more representation vectors to obtain an indication of one or more objects in the image; applying the one or more self-attention based transformers to a third input that is based on the one or more representation vectors to obtain an indication of one or more drivable areas in the image; and outputting the indication of the one or more objects in the image and the indication of the one or more drivable areas in the image.

Aspect 2: The method, apparatus, or non-transitory computer-readable medium of aspect 1, further including operations, features, circuitry, logic, means, or instructions, or any combination thereof for applying the one or more self-attention based transformers to a fourth input based on the one or more representation vectors to obtain an indication of one or more lane lines in the image.

Aspect 3: The method, apparatus, or non-transitory computer-readable medium of any of aspects 1 through 2, where applying the one or more self-attention based transformers to the second input includes determining an attention matrix based on a key vector and a query vector associated with the one or more representation vectors and determining a first feature vector based on the attention matrix and a first value vector associated with the one or more representation vectors, where the indication of the one or more objects includes the first feature vector and applying the one or more self-attention based transformers to the third input includes determining a second feature vector based on the attention matrix and a second value vector associated with the one or more representation vectors, where the indication of the one or more drivable areas includes the second feature vector.

Aspect 4: The method, apparatus, or non-transitory computer-readable medium of aspect 3, further including operations, features, circuitry, logic, means, or instructions, or any combination thereof for applying the one or more self-attention based transformers to a fourth input that is based on the one or more representation vectors to obtain an indication of one or more lane lines in the image, where applying the one or more self-attention based transformers to the fourth input includes determining a third feature vector based on the attention matrix and a third value vector associated with the one or more representation vectors, where the indication of the one or more lane lines includes the third feature vector.

Aspect 5: The method, apparatus, or non-transitory computer-readable medium of any of aspects 1 through 4, where the one or more self-attention based transformers include an encoder including one or more first transformer blocks configured to generate an encoded vector based on the one or more representation vectors and a decoder including one or more decoder blocks configured to generate a decoded vector based on the encoded vector; and the indication of one or more drivable areas is based on the decoded vector.

Aspect 6: The method, apparatus, or non-transitory computer-readable medium of aspect 5, where generating the encoded vector includes identifying one or more attention matrices at each of the one or more first transformer blocks and generating the decoded vector includes applying, at a decoder block of the one or more decoder blocks, an attention matrix of the one or more attention matrices to a value vector associated with the decoder block.

Aspect 7: The method, apparatus, or non-transitory computer-readable medium of any of aspects 5 through 6, where each decoder block of the one or more decoder blocks includes a respective second transformer block of one or more second transformer blocks.

Aspect 8: The method, apparatus, or non-transitory computer-readable medium of any of aspects 5 through 7, where each decoder block of the one or more decoder blocks includes a respective second convolutional layer of one or more second convolutional layers.

Aspect 9: The method, apparatus, or non-transitory computer-readable medium of any of aspects 1 through 8, where receiving the image includes operations, features, circuitry, logic, means, or instructions, or any combination thereof for capturing the image from a camera of a vehicle and inputting the image to a computing platform of the vehicle including the feature extractor and the one or more self-attention based transformers.

Aspect 10: The method, apparatus, or non-transitory computer-readable medium of aspect 9, where the one or more objects in the image correspond to one or more second vehicles.

Aspect 11: The method, apparatus, or non-transitory computer-readable medium of any of aspects 1 through 10, further including operations, features, circuitry, logic, means, or instructions, or any combination thereof for generating one or more second representation vectors using one or more second convolutional layers taking the one or more representation vectors as a fourth input, where the second input includes the one or more second representation vectors.

Aspect 12: The method, apparatus, or non-transitory computer-readable medium of any of aspects 1 through 11, where the one or more self-attention based transformers include an encoder including one or more transformers configured to receive the second input, a decoder including one or more second transformers, and one or more feed forward networks, each feed forward network configured to identify a respective object of the one or more objects.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving an image;
generating, using a feature extractor having one or more convolutional layers and taking the image as a first input, one or more representation vectors corresponding to the one or more convolutional layers;
applying one or more self-attention based transformers to a second input that is based on the one or more representation vectors to obtain an indication of one or more objects in the image;
applying the one or more self-attention based transformers to a third input that is based on the one or more representation vectors to obtain an indication of one or more drivable areas in the image; and
outputting the indication of the one or more objects in the image and the indication of the one or more drivable areas in the image.

2. The method of claim 1, further comprising:
applying the one or more self-attention based transformers to a fourth input based on the one or more representation vectors to obtain an indication of one or more lane lines in the image.

3. The method of claim 1, wherein:
applying the one or more self-attention based transformers to the second input comprises determining an attention matrix based on a key vector and a query vector associated with the one or more representation vectors and determining a first feature vector based on the attention matrix and a first value vector associated with the one or more representation vectors, wherein the indication of the one or more objects comprises the first feature vector; and
applying the one or more self-attention based transformers to the third input comprises determining a second feature vector based on the attention matrix and a second value vector associated with the one or more representation vectors, wherein the indication of the one or more drivable areas comprises the second feature vector.

4. The method of claim 3, further comprising:
applying the one or more self-attention based transformers to a fourth input that is based on the one or more representation vectors to obtain an indication of one or more lane lines in the image, wherein applying the one or more self-attention based transformers to the fourth input comprises determining a third feature vector based on the attention matrix and a third value vector associated with the one or more representation vectors, wherein the indication of the one or more lane lines comprises the third feature vector.

5. The method of claim 1, wherein the one or more self-attention based transformers comprise an encoder comprising one or more first transformer blocks configured to generate an encoded vector based on the one or more representation vectors and a decoder comprising one or more decoder blocks configured to generate a decoded vector based on the encoded vector; and the indication of one or more drivable areas is based on the decoded vector.

6. The method of claim 5, wherein:
generating the encoded vector comprises identifying one or more attention matrices at each of the one or more first transformer blocks; and
generating the decoded vector comprises applying, at a decoder block of the one or more decoder blocks, an attention matrix of the one or more attention matrices to a value vector associated with the decoder block.

7. The method of claim 5, wherein each decoder block of the one or more decoder blocks comprises a respective second transformer block of one or more second transformer blocks.

8. The method of claim 5, wherein each decoder block of the one or more decoder blocks comprises a respective second convolutional layer of one or more second convolutional layers.

9. The method of claim 1, wherein receiving the image comprises:
capturing the image from a camera of a vehicle; and
inputting the image to a computing platform of the vehicle comprising the feature extractor and the one or more self-attention based transformers.

10. The method of claim 9, wherein the one or more objects in the image correspond to one or more second vehicles.

11. The method of claim 1, further comprising:
generating one or more second representation vectors using one or more second convolutional layers taking the one or more representation vectors as a fourth input, wherein the second input comprises the one or more second representation vectors.

12. The method of claim 1, wherein the one or more self-attention based transformers comprise an encoder comprising one or more transformers configured to receive the second input, a decoder comprising one or more second transformers, and one or more feed forward networks, each feed forward network configured to identify a respective object of the one or more objects.

13. An apparatus, comprising: one or more controllers associated with one or more memories, wherein the one or more controllers are configured to cause the apparatus to:
receive an image;
generate, using a feature extractor having one or more convolutional layers and taking the image as a first input, one or more representation vectors corresponding to the one or more convolutional layers;
apply one or more self-attention based transformers to a second input that is based on the one or more representation vectors to obtain an indication of one or more objects in the image;
apply the one or more self-attention based transformers to a third input that is based on the one or more representation vectors to an indication of one or more drivable areas in the image; and
output the indication of the one or more objects in the image and the indication of the one or more drivable areas in the image.

14. The apparatus of claim 13, wherein the one or more controllers are further configured to cause the apparatus to:
apply the one or more self-attention based transformers to a fourth input based on the one or more representation vectors to obtain an indication of one or more lane lines in the image.

15. The apparatus of claim 13, wherein the one or more controllers are further configured to cause the apparatus to:
determine an attention matrix based on a key vector and a query vector associated with the one or more representation vectors;
determine a first feature vector based on the attention matrix and a first value vector associated with the one or more representation vectors, wherein the indication of the one or more objects comprises the first feature vector; and
determine a second feature vector based on the attention matrix and a second value vector associated with the one or more representation vectors, wherein the indication of the one or more drivable areas comprises the second feature vector.

16. The apparatus of claim 15, wherein the one or more controllers are further configured to cause the apparatus to:
apply the one or more self-attention based transformers to a fourth input that is based on the one or more representation vectors to obtain an indication of one or more lane lines in the image, wherein generating the indication of the one or more lane lines comprises determining a third feature vector based on the attention matrix and a third value vector associated with the one or more representation vectors, wherein the indication of the one or more lane lines comprises the third feature vector.

17. The apparatus of claim 13, wherein the one or more self-attention based transformers comprise an encoder comprising one or more first transformer blocks configured to generate an encoded vector based on the one or more representation vectors and a decoder comprising one or more decoder blocks configured to generate a decoded vector based on the encoded vector, and the indication of one or more drivable areas is based on the decoded vector.

18. The apparatus of claim 17, wherein:
generating the encoded vector comprises identifying one or more attention matrices at each of the one or more first transformer blocks; and
generating the decoded vector comprises applying, at a decoder block of the one or more decoder blocks, an attention matrix of the one or more attention matrices to a value vector associated with the decoder block.

19. The apparatus of claim 13, wherein, to receive the image, the one or more controllers are further configured to cause the apparatus to:
capture the image from a camera of a vehicle; and
input the image to a computing platform of the vehicle comprising the feature extractor and the one or more self-attention based transformers.

20. A non-transitory computer-readable medium storing code, the code comprising instructions executable by one or more processors to:
receive an image;
generating, used a feature extractor having one or more convolutional layers and taking the image as a first input, one or more representation vectors corresponding to the one or more convolutional layers;
apply one or more self-attention based transformers to a second input that is based on the one or more representation vectors to obtain an indication of one or more objects in the image;
apply the one or more self-attention based transformers to a third input that is based on the one or more representation vectors to obtain an indication of one or more drivable areas in the image; and
output the indication of the one or more objects in the image and the indication of the one or more drivable areas in the image.
